(19) United States
(12) Patent Application Publication
(10) Pub. No.: US 2006/0060602 A1
(43) Pub. Date: Mar. 23, 2006

(54) Flow control feedback system and method of automatically controlling fluid flow

(76) Inventor: Kwang-Chae Jeong, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/233,169

(22) Filed: Sep. 21, 2005

(30) Foreign Application Priority Data
Sep. 21, 2004 (KR) 2004-75600

(51) Int. Cl. B67D 5/08; B67D 5/14

(52) U.S. Cl. 222/52

(57) ABSTRACT

A fluid control feedback system and a fluid flow control method capable of controlling the flow of fluids used during a manufacturing of semiconductor device are disclosed. A sensing unit senses a dispensed state of a fluid. A monitoring section monitors the dispensed state of the fluid sensed by the sensing unit. A main controller compares a value of the dispensed state sensed by the sensing unit with a set value and correcting the dispensed state of the fluid according to the compared result to output a corrected value. A fluid dispensing controller controls a predetermined device to dispense the fluid based on the corrected value from the main controller.

### CROSS-REFERENCE TO RELATED APPLICATIONS

This U.S. non-provisional patent application claims priority under 35 U.S.C. § 119 of Korean Patent Application 2004-75600 filed on Sep. 21, 2004, the entire contents of which are hereby incorporated by reference.

### BACKGROUND OF THE INVENTION

The present invention relates to a flow control feedback system, more particularly to a flow control feedback system capable of controlling the flow of a fluid and a method for automatically regulating the flow of the fluid using the same in dispensing photo resist or other fluids used in semiconductor wafer processing.

As generally known in the art, semiconductor devices are manufactured through plural processing steps. Before carrying out an etch process in the semiconductor devices in the various processes, a process for uniformly coating a wafer with a photoresist is generally performed. Such a photoresist coating process is performed by means of a coater unit of spinner equipment.

A photoresist coating device such as a coater unit includes a nozzle that dispenses the photoresist on the wafer. When the operation for dispensing the photoresist by the nozzle is terminated, photoresist is sucked into the nozzle by an operation of a valve. Such a sucking-back operation of the photoresist prevents a surface of the photoresist from being solidified to some degree.

If the sucking-back operation is abnormally performed, photoresist in the nozzle tip is solidified. When the solidified photoresist is dispensed onto the wafer, a degraded coating occurs. This causes a degradation of the product by lowering yield or peeling of the photoresist, thereby further requiring corrective operations. As a result, yield ability of a product is reduced.

Furthermore, upon continuously performing the photoresist coating process, the amount of dispensed photoresist can exceed an initially set coating range. When the dispensing of photoresist is cut off at the nozzle, namely, an end position of the dispensing is beyond an initial condition, subsequent dispensing of the photoresist is affected, causing the occurrence of a coating deterioration. The aforementioned problems occur in all kinds of fluids used during manufacturing of the semiconductor device as well as photoresist.

### SUMMARY OF THE INVENTION

The present invention is directed to a fluid control feedback system and method capable of controlling the flow of fluids used for manufacturing a semiconductor device.

In order to achieve the object, the fluid control feedback system and the fluid flow control method sense a dispensed amount of fluid, and cut off and sucking-back operations by a sensor provided at a nozzle for dispensing the fluid, and feedback sensed data in order to automatically control the fluid.

An aspect the present invention is to provide a flow control feedback system comprising: a sensing unit for sensing a dispensed state of a fluid; a monitoring section for monitoring the dispensed state of the fluid sensed by the sensing unit; a main controller for comparing a value of the dispensed state sensed by the sensing unit with a set value and correcting the dispensed state of the fluid according to the compared result to output a corrected value; and a fluid dispensing controller for controlling a predetermined device to dispense the fluid based on the corrected value from the main controller.

Preferably, the system further comprises a display section for displaying the dispense state of fluid monitored by the monitoring section that allows a user to visually confirm the dispense state of the fluid. More preferably, the predetermined device is an air valve for dispensing the fluid at air pressure. Most preferably, the fluid dispensing controller is an air valve controller for controlling the air valve. In one embodiment, the sensing unit includes a dispenser for dispensing the fluid, a housing providing a space in which the dispenser resides, and a sensor for sensing the dispensed state of the fluid dispensed in the dispenser.

In one embodiment, the sensor includes a first sensor for dispensed amount of the fluid, a second sensor for sensing a cut-off position of the fluid when the dispenser cuts-off the fluid, and a third sensor for sensing a suck-back position of the fluid when the dispenser sucks back the fluid. In the embodiment, at least one of the first, second, and third sensors includes a light emitting section and a light receiving section that are arranged on opposite of the dispenser, respectively. In the embodiment, the first sensor is a sensor for sensing a tip position of the dispenser.

In one embodiment, the dispenser is made of a light permeable material for transmitting light emitted by a photo sensor. In the embodiment, the sensor includes a bar shaped light emitting section for emitting light to the dispenser, and a bar shaped light receiving section for sensing light emitted from the shaped light emitting section. In the embodiment, the bar shaped light receiving section senses a tip position of the dispenser, a cut-off position of the fluid, and a suck-back position of the fluid. In the embodiment, the dispenser is made of a light permeable material for transmitting light emitted by the light emitting section. In the embodiment, the fluid includes photoresist.

According to another aspect of the present invention, there is provided a method for controlling a flow of a fluid, the method comprising: (i) dispensing the fluid using a dispenser; (ii) sensing a state of the dispensed fluid; (iii) comparing a value of the sensed state of the dispensed fluid with a set state value of the fluid; and (iv) correcting a dispensing condition of the dispenser to correspond the sensed state value of the dispensed fluid to the set state value of fluid when the sensed state value of the dispensed fluid is different from the set state value of fluid.

Preferably, step (i) includes periodically dispensing the fluid using the dispenser. More preferably, dispensing the fluid using the dispenser periodically uses a standby time interval before, after, or during dispensing of the fluid using the dispenser in a real process. Most preferably, step (ii) includes a first step of sensing amount of the fluid dispensed to the dispenser, a second step of sensing a position that the dispenser cuts-off the fluid, and a third step of sensing a position that the dispenser sucks back the fluid. In the embodiment, at least one of the first, second, and third steps uses a photo sensor.

In one embodiment, at least one of steps (i), (ii), (iii), and (iv) is performed by a flow control feedback system including a sensing unit for sensing a dispensed state of fluid; a monitoring section for monitoring the dispensed state of fluid sensed by the sensing unit; a main controller for comparing a value of the dispensed state sensed by the sensing unit with a set value and correcting the dispensed state of fluid according to the compared result to output a corrected value; and a fluid dispensing controller for controlling a predetermined device to dispense the fluid based on the corrected value from the main controller. In the embodiment, the fluid includes photoresist.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a block diagram showing a flow control feedback system according to an embodiment of the present invention;

FIG. 2 is a view showing the sensing unit shown in FIG. 1;

FIG. 3 is a view showing an example of the sensing unit having nozzles and sensors shown in FIG. 2;

FIG. 4 is a view illustrating a sensing operation by the nozzles and the sensors of the sensing unit in FIG. 3;

FIG. 5 is a view showing another example of the sensing unit having nozzles and sensors shown in FIG. 2;

FIG. 6 is a view illustrating a sensing operation by the nozzles and the sensors of the sensing unit in FIG. 5; and

FIG. 7 is a flow chart illustrating a method for automatically controlling a flow of fluid according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and its construction should not be limited to the embodiments set forth herein. Rather, these embodiments are provided so that this disclosure will be thorough and complete, and will fully convey the scope of the invention to those skilled in the art. Like numerals refer to like elements throughout the specification.

### EMBODIMENT

Hereinafter, described is an exemplary embodiment of the present invention in conjunction with the accompanying drawings.

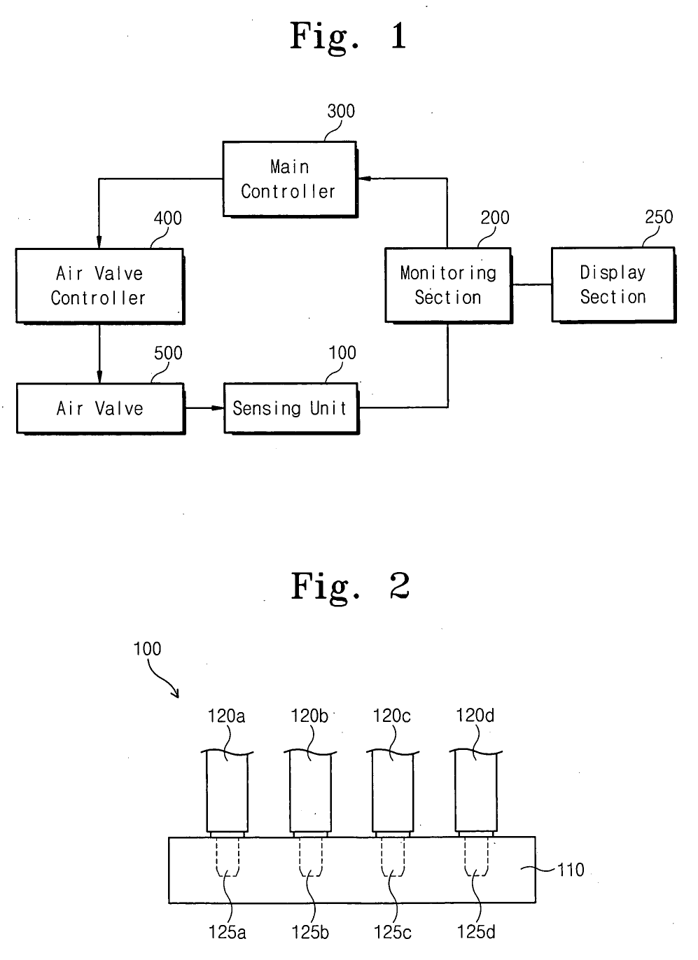

FIG. 1 is a block diagram showing a flow control feedback system according to an embodiment of the present invention. Referring to FIG. 1, the flow control feedback system according to the present invention includes a sensing unit 100, a monitoring section 200, a main controller 300, an air valve controller 400, and an air valve 500.

The sensing unit 100 senses the dispensed amount of a fluid used during a manufacturing of semiconductor devices, namely, for example a photoresist used during a photo lithographic process. The sensing unit 100 also senses a cut off operation and a suck-back operation. The description thereof will be given below in more detail.

The monitoring section 200 monitors the sensing unit 100, and collects dispensed amount data, cut-off position data, and suck-back position data of the photoresist sensed by the sensing unit 100. In order to do this, the monitoring section 200 may include a programmable logic controller. The monitoring section 200 further includes a display section 250 for displaying operations and data monitored by the monitoring section 200 so that a user can visually confirm it in real time.

The main controller 300 is a device for controlling an entire photoresist coating process. The main controller 300 receives the collected data from the monitoring section 200, compares it with initial set data, and corrects a dispensed state of the fluid according the compared result. Amount data, cut-off position data, and sucked-back position data of the photoresist dispensed from the nozzle are previously set by the main controller 300. Such set data are transferred to the air valve controller 400. This causes the air valve controller 400 to operate the air valve 500. As the photoresist coating process continues, the amount, the cut-off position value, or the sucked-back position value of the photoresist dispensed from the nozzle can exceed the initial set values. The main controller 300 receives and compares amount data, cut-off position data, or sucked-back position data of the photoresist dispensed from the nozzle with the amount set value, the cut-off position set value, and the sucked-back position set value, respectively. The main controller 300 corrects the amount set data, the cut-off position set data, and the sucked-back position set data according to the compared result, and provides the corrected data to the air valve controller 400. The air valve controller 400 operates the air valve 500 based on the corrected data from the main controller 300.

The air valve controller 400 operates the air valve 500 based on set data. That is, the air valve controller 400 controls the air valve 500 that causes the nozzle to dispense the photoresist at a predetermined pressure. Furthermore, this operation causes the dispensing of the photoresist to be cut off at a position away from a nozzle tip by a predetermined distance and causes the photoresist to be sucked back at a position away from the nozzle by a predetermined distance. As stated above, when the dispensing data for the photoresist are corrected, the air valve controller 400 receives the corrected data from the main controller 300, and controls the air valve 500 to dispense the photoresist based on the corrected data.

The air valve 500 is a device for dispensing the photoresist using air pressure by means of a nozzle of the sensing unit 100. At this time, the nozzle of the sensing unit 100 dispenses the photoresist at constant flow rate.

FIG. 2 is a view showing one embodiment of the sensing unit 100 shown in FIG. 1. Referring to FIG. 2, the sensing unit 100 includes at least one nozzle 120a, 120b, 120c, and 120d, and a housing 110. The housing 110 receives the photoresist dispensed from the nozzle 120a, 120b, 120c, and 120d and provides spaces in which the cut-off position and the sucking-back position are sensed. The coater equipment is typically provided with a home port. The nozzle dispensing the photoresist on the wafer waits the home port. Accordingly, a home port formed in conventional coater equipment may be used as the housing 110 of the present invention. Otherwise, regardless of usage of the home port, the housing 110 can be additionally provided.

Typically, the coater equipment includes a plurality of nozzles. According to the process, one of the nozzles dispenses a photoresist containing specific components, another nozzle dispenses a photoresist containing different components from the specific components. Accordingly, it is desired that the housing 110 can receive the nozzles 120a, 120b, 120c, and 120d capable of dispensing the photoresist having the aforementioned components. Sensors (not shown) are disposed at both sides of nozzle tips 125a, 125b, 125c, and 125d that are positioned at respective ends of the nozzles 120a, 120b, 120c, and 120d. The sensors sense dispensing amount and state of the photoresist.

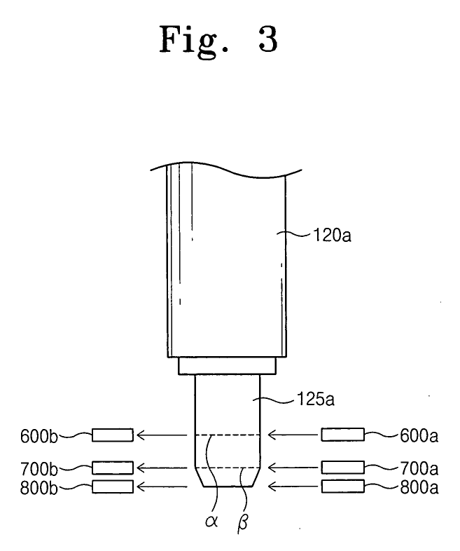

FIG. 3 is a view showing an example of the sensing unit having nozzles and sensors shown in FIG. 2. With reference to FIG. 3, a nozzle tip position sensor includes a light emitting section 800a and a light receiving section 800b that are arranged on opposite sides of the nozzle tip 125a and sense an end of the nozzle tip 125a by using light. A cut-off position sensor includes a light emitting section 700a and a light receiving section 800b that are arranged on opposite sides of the nozzle tip 125a corresponding to a position higher than the lower most position of nozzle tip 125, and sense a cut-off position β of the photoresist by using the light. A sucking-back position sensor 600a and 600b includes a light emitting section 600a and a light receiving section 600b that are arranged on opposite sides of the nozzle tip 125a corresponding to a position higher than the cut-off position sensor 700a and 700b, and sense a sucking-back position a of the photoresist.

On the other hand, since a photo sensor senses a dispensing amount, a cut-off position, and a sucking-back position of the photoresist, it is desired that a member formed of material capable of transmitting light (i.e., light permeable) be used as the nozzle tip 125a.

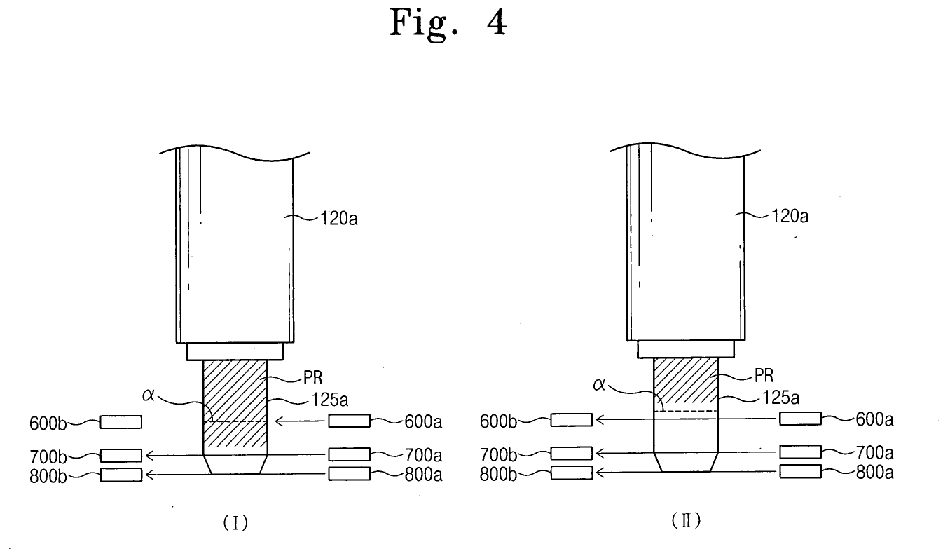

FIG. 4 is a view that illustrates a sensing operation by the nozzles and the sensors of the sensing section in FIG. 3, in an operation of sensing a sucking-back position of the photoresist PR. Referring to FIG. 4, after the photoresist dispensing is terminated, in order to prevent the photoresist from being solidified, an operation for sucking-back the photoresist from the nozzle tip 125 by a predetermined distance (e.g., 3˜4 mm) is performed. At this time, the photoresist PR should be sucked-back to a set sucking-back position α. However, when the photoresist does not reach the suck-back position α (I) or if an excessive photoresist is sucked-back (II), then during a subsequent dispensing operation, an error occurs in dispensed amount of the photoresist.

Since the photoresist interrupts a path of light for a predetermined time during the sucking-back operation, the light receiving section 600b of the sucking-back position sensor does not sense light emitted by the light emitting section 600a. However, when a time corresponding to an end of a sucking-back time has elapsed and the light receiving section 600b senses the light emitted by the light emitting section 600a, there are no photoresist in a sensing area. It is discriminated that a normal suck-back operation is performed.

In case (I), although the time corresponding to the end of the sucking-back time has elapsed, the light receiving section 600b cannot sense light at a set sucking-back position α, In case (II), although the time corresponding to the end of the sucking-back time has not elapsed, the light receiving section 600b senses light at a set sucking-back position α. In each case, it is discriminated that a sucking-back operation was abnormally performed. That is, the first case (I) indicates an insufficient sucking-back operation was carried out, whereas the second case (II) indicates that an excessive sucking-back operation was performed. In the same manner, it can be discriminated whether or not a cut-off operation is normally performed.

A method for sensing dispensed amount of the photoresist is as follows. The photoresist is dispensed by a predetermined pressure. Accordingly, a constant amount of the photoresist is dispensed for a constant time. Accordingly, dispensed amount of the photoresist is obtained based on a measured dispensing time of the photoresist from the nozzle tip 125a. For example, so as to obtain a dispensed amount of the photoresist corresponding to the set dispensed amount of the photoresist, the photoresist should be dispensed for a time period ΔT (=T2−T1). That is, the light receiving section 800b of the nozzle tip position sensor should not sense light emitted from the light emitting section 800a thereof for the time period ΔT. If the time period ΔT has not yet elapsed, when the light receiving section 800b senses the light, it indicates that the photoresist is dispensed less than a set dispensed amount. In contrast to this, if the time period ΔT has elapsed, when the light receiving section 800b does not sense the light, it indicates that the photoresist is dispensed in excess of the set dispensed amount.

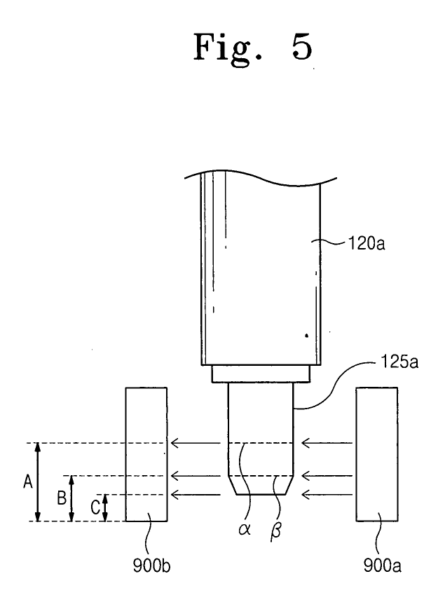

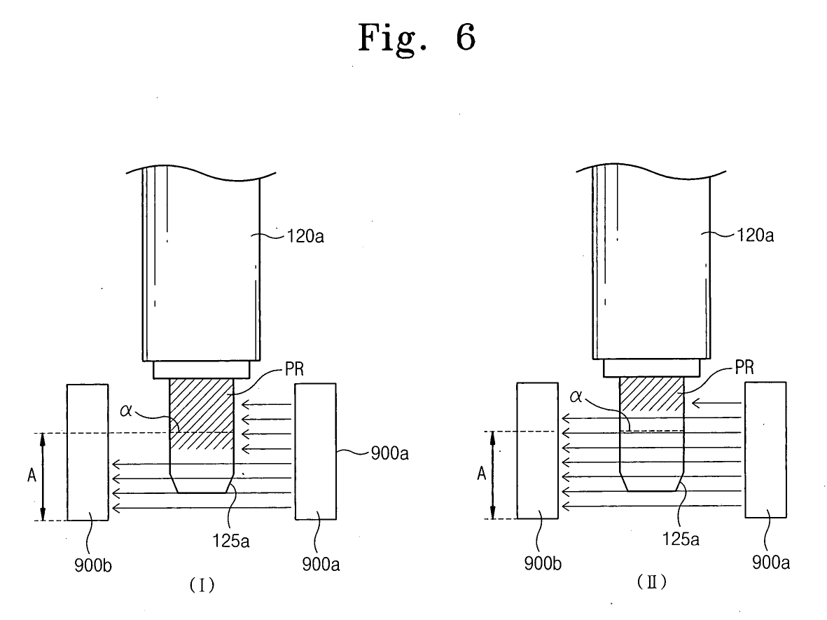

FIG. 5 is a view showing another example of the sensing unit having nozzles and sensors shown in FIG. 2 that senses a dispensed state of the photoresist. Referring to FIG. 5, a position sensor is composed of a bar shaped light emitting section 900 and a bar shaped light receiving section 900b that are disposed on opposite sides of the nozzle tip 125a. The light emitting section 900a emits the light to a front face of the nozzle tip 125a, and the light receiving section 900b senses the light passed through the nozzle tip 125a. The light receiving section 900b senses an end position of the nozzle tip 125a, a cut-off position β, and a sucking-back position α, based on whether or not lights to an area C, an area B, and an area A are sensed, respectively.

FIG. 6 is a view that illustrates an operation of sensing a sucking-back position a by the nozzles and the sensors of the sensing unit in FIG. 5. Referring to FIG. 6, a sucking-back operation completing a photoresist dispensing is carried out. At the time corresponding to an end of the sucking-back time, when the light receiving section 900b senses light to an interval A but does not sense light beyond that interval, it is judged that the sucking-back operation was normally performed.

As shown in FIG. 6 case (I), if the sucking-back time has elapsed, when an area in which the light is not sensed is present within the interval A, it means that the photoresist PR is not sucked-back to the sucking-back position α for the set sucking-back time. That is, a sufficient sucking-back operation is not performed. To the contrary, in case (II), if the sucking-back time has not yet elapsed, when the light receiving section 900b senses the light beyond the area A, it is judged that the photoresist PR is excessively sucked-back beyond the sucking-back position α. In the same manner as in the sucking-back operation, it can be discriminated whether or not a cut-off operation is normally performed.

Dispensed amount of the photoresist is measured based on a time of whether or not light is sensed in an area C. For example, so as to obtain dispensed amount of the photoresist corresponding to set dispensed amount, the photoresist should be dispensed for a time period ΔT (=T2−T1). Referring back to FIG. 5, an area C of the light receiving section 900b should not sense light emitted from the light emitting section 900a for the time period ΔT. However, if the time period ΔT has not yet elapsed, when any part of the area C of the light receiving section 900b senses light, it indicates that the photoresist is dispensed less than the set dispensed amount. In contrast to this, if the time period ΔT has already elapsed, when there is a part of the area C of the light receiving section 900b that does not sense the light, it indicates that the photoresist is dispensed in excess of the set dispensed amount.

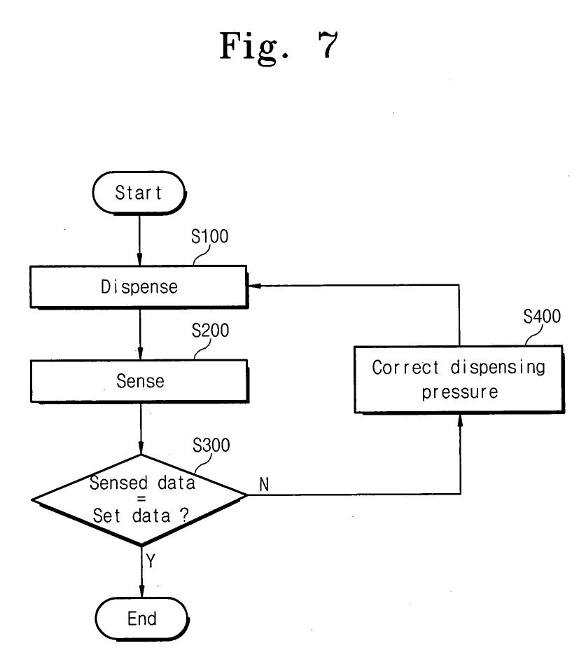

FIG. 7 is a flow chart that illustrates a method for automatically controlling a flow of a fluid according to an embodiment of the present invention. With reference to FIG. 7, before or during a process of dispensing the photoresist on the wafer, the nozzle moves above the wafer at a wait position in the housing 110. For example, when a plurality of nozzles 120a˜120d are installed according to components of the photoresist, it is assumed that first, second, third, and fourth nozzles 120a, 120b, 120c, and 120d dispense first, second, third, and fourth photoresists, respectively. For example, while the first photoresist is dispensed on the wafer through the first nozzle 102a, the second, third, and fourth nozzles 120b, 120c, and 120d are positioned at a waiting position in the housing 110.

When the second, third, and fourth nozzles 120b, 120c, and 120d are positioned in a waiting or standby status in the housing 110, in order to prevent the photoresist from being solidified, the second, third, and fourth nozzles 120b, 120c, and 120d dispense the second, third, and fourth photoresists every predetermined period, respectively. In this case, the photoresist is dispensed at the same condition as that of a real coating process. In addition to the second, third, and fourth nozzles 120b, 120c, and 120d being in the standby or idle status, a current in use nozzle 120a dispenses the first photoresist every predetermined period (step S100). In other words, before, after, or during the real coating process, the photoresist is periodically dispensed through a predetermined nozzle, namely, in a dummy dispense cycle under the same condition as that of the real coating process (step S100).

During the dummy dispense operation, the aforementioned photo sensor senses dispensed amount, a cut-off position, and a sucking-back position of the photoresist (step S200). At this time, the air valve controller 400 controls the air valve 500 to be operated. The operation of the air valve 500 causes the sensing unit 100 to sense the dispensed state of the photoresist based on the set data. The monitoring section 200 collects data sensed by the sensing unit 100 and transfers it to the main controller 300.

The main controller 300 compares dispensed amount of the photoresist sensed as a dummy dispensing of photoresist in a set amount (step S300). Furthermore, the main controller 300 compares the sensed cut-off position data and sucking-back position data with set data (step S300). When the sensed data are identical with the set data, the main controller 300 judges that the photoresist dispensing operation was normally performed. To the contrary, when the sensed data are different from the set data, namely, the dispense amount of the photoresist does not reach the set data or exceeds the set data, the main controller 300 provides a correcting value for the dispensing condition to the air valve controller 400, thereby correcting a dispensing pressure of the photoresist (step S400). Accordingly, the air valve controller 400 controls the air valve 500 that allows the nozzle to dispense the photoresist according to the corrected dispensing condition.

Such a set data correction is applicable to the cut-off position and the sucking-back position of the photoresist in addition to the dispensed amount of the photoresist. After the nozzle dispenses the photoresist based on the corrected set data, a series of procedures as mentioned above repeats every predetermined period, thereby automatically adjusting the photoresist dispensing.

Although the present invention has been described in connection with the dispensing operation of the photoresist, it is not limited to thereto. It will be apparent to those skilled in the art that the present invention is applicable to flow adjustment of fluids other than the photoresist.

Additional advantages and modifications will readily occur to those skilled in the art. Therefore, the invention in its broader aspects is not limited to the specific details and representative embodiments shown and described herein. Accordingly, various modifications may be made without departing from the scope and spirit of the general inventive concept as defined by the appended claims and their equivalents.

As mentioned above, the present invention automatically controls a flow of fluid dispensed from a nozzle. Furthermore, the present invention simultaneously monitors cut-off and sucking-back operations of the fluid in addition to an adjustment of dispensed amount of the fluid, and exactly controls a fluid flow by feedbacking the monitored data. Therefore, the deterioration of products is greatly reduced, improving yield and productivity.

What is claimed is:

1. A flow controlling feedback system comprising:
a sensing unit for sensing a dispensed state of a fluid;
a monitoring section for monitoring the dispensed state of the fluid sensed by the sensing unit;
a main controller for comparing a value of the dispensed state sensed by the sensing unit with a set value and correcting the dispensed state of the fluid according to the compared result to output a corrected value; and
a fluid dispensing controller for controlling a predetermined device to dispense the fluid based on the corrected value from the main controller.

2. The system as set forth in claim 1, further comprising a display section for displaying the dispense state of fluid monitored by the monitoring section that allows a user to visually confirm the dispense state of the fluid.

3. The system as set forth in claim 1, wherein the predetermined device is an air valve for dispensing the fluid at air pressure.

4. The system as set forth in claim 3, wherein the fluid dispensing controller is an air valve controller for controlling the air valve.

5. The system as set forth in claim 1, wherein the sensing unit includes a dispenser for dispensing the fluid, a housing providing a space in which the dispenser resides, and a sensor for sensing the dispensed state of the fluid dispensed in the dispenser.

6. The system as set forth in claim 5, wherein the sensor includes a first sensor for sensing dispensed amount of the fluid, a second sensor for sensing a cut-off position of the fluid when the dispenser cuts-off the fluid, and a third sensor for sensing a suck-back position of the fluid when the dispenser sucks back the fluid.

7. The system as set forth in claim 6, wherein at least one of the first, second, and third sensors includes a light emitting section and a light receiving section that are arranged on opposite sides of the dispenser, respectively.

8. The system as set forth in claim 6, wherein the first sensor is a sensor for sensing a tip position of the dispenser.

9. The system as set forth in claim 6, wherein the dispenser is made of a light permeable material for transmitting light emitted by the light emitter to a photo sensor.

10. The system as set forth in claim 5, wherein the sensor includes a bar shaped light emitting section for emitting light to the dispenser, and a bar shaped light receiving section for sensing light emitted from the bar shaped light emitting section.

11. The system as set forth in claim 10, wherein the bar shaped light receiving section senses a tip position of the dispenser, a cut-off position of the fluid, and a suck-back position of the fluid.

12. The system as set forth in claim 10, wherein the dispenser is made of a light permeable material for transmitting light emitted by the light emitting section.

13. The system as set forth in claim 1, wherein the fluid includes photoresist.

14. A method for controlling a flow of a fluid, the method comprising the steps of:
(i) dispensing the fluid using a dispenser;
(ii) sensing a state of the dispensed fluid;
(iii) comparing a value of the sensed state of the dispensed fluid with a set state value of the fluid; and
(iv) correcting a dispensing condition of the dispenser to correspond the sensed state value of the dispensed fluid to the set state value of fluid when the sensed state value of the dispensed fluid is different from the set state value of fluid.

15. The method as set forth in claim 14, wherein step (i) includes periodically dispensing the fluid using the dispenser.

16. The method as set forth in claim 15, wherein periodically dispensing the fluid using the dispenser during a standby time interval before, after, or during dispensing of the fluid in a real process.

17. The method as set forth in claim 14, wherein sensing step (ii) includes a first step of sensing an amount of the fluid dispensed from the dispenser, a second step of sensing a position that the dispenser cuts-off the fluid, and a third step of sensing a position that the dispenser sucks back the fluid.

18. The method as set forth in claim 17, wherein at least one of the first, second, and third steps uses a photo sensor.

19. The method as set forth in claim 14, wherein at least one of steps (i), (ii), (iii), and (iv) is performed by a flow control feedback system including a sensing unit for sensing a dispensed state of fluid; a monitoring section for monitoring the dispensed state of fluid sensed by the sensing unit; a main controller for comparing a value of the dispensed state sensed by the sensing unit with a set value and correcting the dispensed state of fluid according to the compared result to output a corrected value; and a fluid dispensing controller for controlling a predetermined device to dispense the fluid based on the corrected value from the main controller.

20. The method as set forth in claim 19, wherein the fluid includes photoresist.

21. A method for controlling a flow of a fluid for a semiconductor manufacturing process, the method comprising:
providing a dispenser structured to dispense a fluid; and
periodically dispensing the fluid using the dispenser during a standby time interval before, after, or during dispensing of the fluid in a real process for preventing the fluid from being solidified.

22. The method of claim 21, further comprising:
(ii) sensing a state of the dispensed fluid;
(iii) comparing a value of the sensed state of the dispensed fluid with a set state value of the fluid; and
(iv) correcting a dispensing condition of the dispenser to correspond the sensed state value of the dispensed fluid to the set state value of fluid when the sensed state value of the dispensed fluid is different from the set state value of fluid.
